(19) United States
(12) Patent Application Publication
(10) Pub. No.: US 2024/0390933 A1
(43) Pub. Date: Nov. 28, 2024

(54) SLOT DIE COATING APPARATUS AND THE COATING METHOD THEREOF

(71) Applicant: PROLOGIUM TECHNOLOGY CO., LTD., Taoyuan City (TW)

(72) Inventors: Chia-Ming LIN, Taoyuan City (TW); Szu-Nan YANG, Taoyuan City (TW); Chia-Chi HUANG, Taoyuan City (TW)

(73) Assignee: PROLOGIUM TECHNOLOGY CO., LTD., Taoyuan City (TW)

(21) Appl. No.: 18/655,922

(22) Filed: May 6, 2024

(30) Foreign Application Priority Data
May 23, 2023 (TW) 112119054

(51) Int. Cl. B05C 5/02

(52) U.S. Cl. CPC B05C 5/0266

(57) ABSTRACT

The invention provides a slot die coating apparatus and the coating method thereof. The flow path is divided into a first flow path and a second flow path by the shim group. The first flow path is utilized to coat from the middle portion of the coating nozzle and the second flow path is utilized to coat from the two sides of the coating nozzle. The height for coating of the slot die coating apparatus is adjustable, and the slurry may be exposed from the first flow path or the second flow path. Therefore, hitting the obstacle of the substrate can be avoided during coating to achieve the optimized coating.

### BACKGROUND OF THE INVENTION

### Cross References to Related Applications

The present application claims priority to Taiwanese Patent Application 112119054 filed in the Taiwanese Patent Office on May 23, 2023, the entire contents of which is being incorporated herein by reference.

### Field of Invention

The present invention relates to a die coating apparatus, in particular to a die coating apparatus with two completely separated flow paths and the related coating method.

### Related Art

A slot coating head is utilized to dispense the slurry through a slot nozzle for the slot die coating to coat on the substrate to be coated. The slot nozzle is very suitable for large-area coating due to its broader width. It can be used with rollers or conveyors to achieve a continuous coating.

However, in case of that the components are presented on the substrate, the components on the substrate will form a three-dimensional obstacle during the slot coating process. For example, when a frame-shaped coating is to be carried out around the component, due to the existence of the obstacle, the frame-shaped coating cannot be completed in a single one process. However, it is considered that the slot coating is still an efficient process to be used. Therefore, the conventional method is to coat one pair of corresponding two sides of the frame first, then rotate the substrate ninety degrees to coat another set of two opposite sides. In this way, the overall process steps will become complex and time-consuming, and it will also be difficult to achieve continuous mass production.

Furthermore, in case of the thickness of the component on the substrate is relatively large, when the coating head passes through the component, the slot nozzle at the bottom may collide with the component and scratch the surface of the component. Therefore, in this case, the frame-shaped coating must be carried out on each of the four sides respectively. The complexity and time cost of the overall process will be greatly increased.

Therefore, this invention provides a slot die coating apparatus and the coating method thereof to mitigate or obviate the aforementioned problems.

### SUMMARY OF THE INVENTION

It is an objective of this invention to provide a brand new slot die coating apparatus and the coating method thereof, which can achieve a single one process to form a frame-shaped coating on substrates with obstacles without significantly changing the structure of the slot coating head device by utilizing the shim group. Therefore, the process complexity and manufacturing costs are significantly reduced.

Also, it is another objective of this invention to a slot die coating apparatus and the coating method thereof. The flow path of the slot die coating apparatus is divided into a first flow path and a second flow path to coat the lateral and longitudinal sides of the frame-shaped coating respectively. Therefore, a frame-shaped coating around the component is achieved by a single slot die coating apparatus via a single one process. Also, the height of the slot die coating apparatus is adjustable to avoid the collision between the slot die coating apparatus and the components on the substrate, and the coating quality is optimized.

In order to implement the abovementioned, this invention discloses a slot die coating apparatus, which includes an upper mold, a lower mold and a shim group. The upper mold includes an upper inlet and a first slurry storage slot connected to the upper inlet. The lower mold includes a lower inlet and a second slurry storage slot connected to the lower inlet. The shim group is sandwiched between the upper mold and the lower mold, and includes a central shim plate, an upper shim plate and a lower shim plate. The upper shim plate has at least one notch and is sandwiched between the central shim plate and the upper mold. The notch is connected to the first slurry storage slot to dispense a slurry from the upper inlet for coating. The lower shim plate is sandwiched between another side of the central shim plate and the lower mold, and has at least one first flow path slot and at least one second flow path slot to dispense a slurry from the lower inlet for coating, which are connected to the second slurry storage slot. The first flow pate slot and the second flow path slot are located at two ends of the notch respectively and are partially overlapped with the notch. It is controlled to dispense the slurry from the notch in front of and behind the obstacle of the substrate to form the lateral sides, and dispense the slurry from the first flow path slot and the second flow path slot on both sides of the obstacle of the substrate to form the longitudinal sides on the substrate. Therefore, a frame-shaped coating around the component is achieved via a single one process. The the collision between the slot die coating apparatus and the components on the substrate is avoided.

This invention further discloses a slot die coating method, adapted for coating on a substrate with an obstacle, utilized the above-mentioned slot die coating apparatus to coat the slurry around the obstacle of the substrate to form a frame, the slot die coating method comprising the steps of:
providing the substrate with the obstacle and a slot die coating apparatus;
dispensing the slurry from the notch in front of the obstacle of the substrate to form a first lateral side;
closing the dispensing from the notch when detecting close to the obstacle and moving the slot die coating apparatus far away from the substrate to prevent it from colliding the obstacle;
dispensing the slurry from the first flow path slot and the second flow path slot on both sides of the obstacle of the substrate to form a first longitudinal side and a second longitudinal side on the substrate;
closing the dispensing from the first flow path slot and the second flow path slot when detecting pass the obstacle and moving the slot die coating apparatus to an original height with respect to the substrate; and
dispensing the slurry from the notch behind the obstacle of the substrate to form a second lateral side.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a schematic diagram of the embodiments of the slot die coating apparatus of this invention.

FIG. 2 is an exploded view of the embodiments of the slot die coating apparatus of this invention.

FIG. 3 is a schematic diagram of the embodiments of the slot die coating apparatus of this invention, showing the coating condition.

FIGS. 4A-4D are schematic diagrams of the embodiments of the slot die coating method of this invention.

FIGS. 5A-5B are schematic diagrams of the embodiments of the slot die coating method of this invention.

FIGS. 6A-6B are schematic diagrams of the embodiments of the slot die coating method of this invention.

FIGS. 7A-7B are schematic diagrams of the embodiments of the slot die coating method of this invention.

FIGS. 8A-8B are schematic diagrams of the embodiments of the slot die coating method of this invention.

### DETAILED DESCRIPTION OF THE INVENTION

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise. Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

In the description of the present invention, it should be noted that the terms “installation”, “connected”, and “disposed” are to be understood broadly, and may be fixed or detachable, for example, can be mechanical or electrical, can be connected directly or indirectly, through an intermediate medium, which can be the internal connection between two components. The specific meanings of the above terms in the present invention can be understood in the specific circumstances by those skilled in the art.

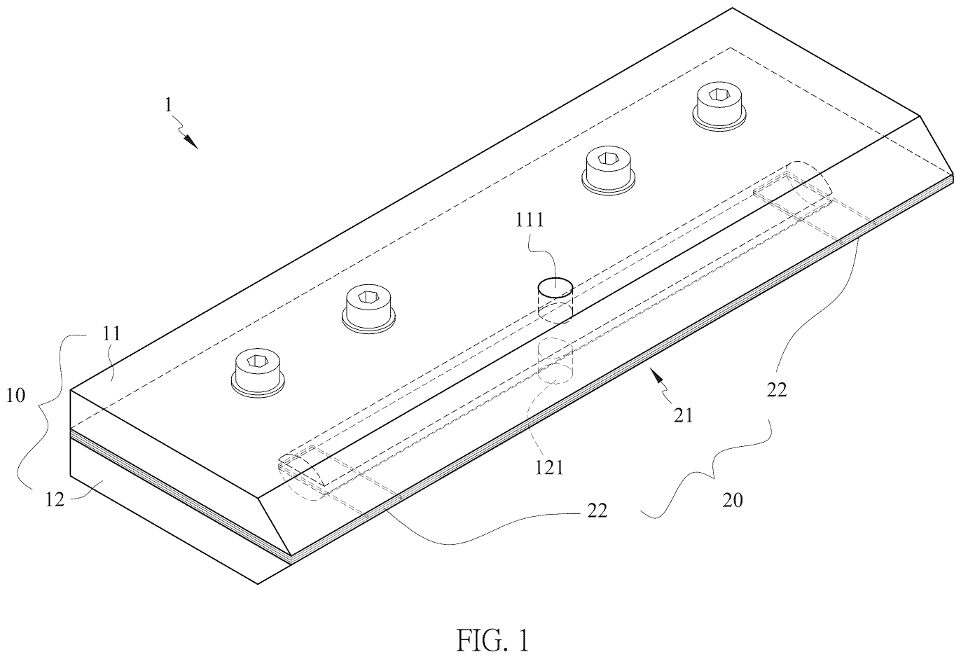

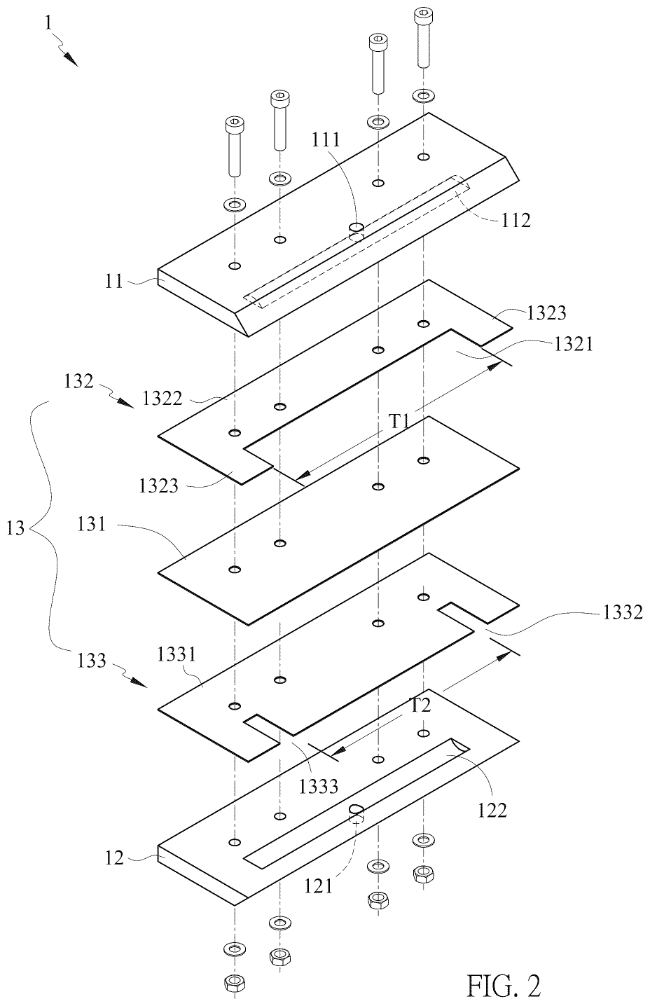

This invention discloses a slot die coating apparatus. Please refer to FIGS. 1-2, the slot die coating apparatus 1 includes a die body 10 and a coating nozzle 20 located on the bottom of the die body 10. The slurry is driven into the die body 10 via an external equipment such as a pump, and then is dispensed through the coating nozzle 20. The details of the external equipment such as a pump are the same as those of the conventional slot coating head. Therefore the external pump is ignored in the figure. In the figures, the slot die coating apparatus 1, which is the feature of this invention, is mainly shown.

As shown in FIGS. 1-2, the die body 10 is composed of an upper mold 11, which has trapezoidal cross section, and a lower mold 12, which has trapezoidal cross section. The upper mold 11 includes a first slurry storage slot 112, and the lower mold 12 includes a second slurry storage slot 122. Also, the upper mold 11 and the lower mold 12 include an upper inlet 111 and a lower inlet 112, which are complete separated, respectively. The upper inlet 111 is connected to the first slurry storage slot 112 and the lower inlet 121 is connected to the second slurry storage slot 122. In the conventional structure, the upper mold 11 and the lower mold 12 are coupled with each other directly. The first slurry storage slot 112 and the second slurry storage slot 122 will be assembled to form a single flow path. The coating nozzle, formed in the ends at the inclined planes of the two trapezoids, discharges the slurry for coating. However, in this invention, the shim group 13 is disposed and sandwiched between the upper mold 11 and the lower mold 12 to completely separate the first slurry storage slot 112 and the second slurry storage slot 122. Therefore, the first flow path and the second flow path, which are not connected to each other, will be formed.

The shim group 13 is sandwiched between the upper mold 11 and the lower mold 12, and includes a central shim plate 131, an upper shim plate 132 and a lower shim plate 133. The central shim plate 131 is substantially a thin square plate, and has a size equal to the sizes of the upper mold 11 and the lower mold 12. The central shim plate 131 does not have any holes or slots in the positions corresponding to the first slurry storage slot 112 and the second slurry storage slot 122. Therefore, the first slurry storage slot 112 and the second slurry storage slot 122 are completely separated to form the first flow path and the second flow path, which are not connected to each other. The upper shim plate 132 is U-shaped, and includes an upper shim plate body 1322 and two extended portions 1323, extended from the two side edges of the upper shim plate body 1322 toward to the coating nozzle 20. Therefore, a notch 1321 will be formed in the middle portion. The width of the notch 1321 is T1. The upper shim plate 132 is flatly disposed on the central shim plate 131. The notch 1321 is connected to most parts of the first slurry storage slot 112, and only two edges of the first slurry storage slot 112 are shielded. The slurry from the first slurry storage slot 112 will be blocked by the central shim plate 131 to expose from the notch 1321 to form a first flow path, which dispense the slurry from the middle portion of the coating nozzle 20. Please refer to FIGS. 1-2, the notch 1321 is corresponding to the first outlet 21.

The lower shim plate 133 is sandwiched between another side of the central shim plate 131 and the lower mold 12. The lower shim plate 133 includes a lower shim plate body 1331 and at least two flow path slots, a first flow path slot 1332 and a second flow path slot 1333. The two flow path slots are located on the lower shim plate 1331 and extended toward to the coating nozzle 20 to from opening ends. The slurry from the second slurry storage slot 122 will be blocked by the central shim plate 131 to expose from the first flow path slot 1332 and the second flow path slot 1333 to form a second flow path, which dispense the slurry from the both sides of the coating nozzle 20. Please refer to FIGS. 1-2, the first flow path slot 1332 and the second flow path slot 1333 is corresponding to the second outlet 22. As shown in FIG. 1, for the die body 10, the second outlets 22 are located two sides of the first outlet 21.

By separation of the central shim plate 131, the first flow path and the second flow path, which are formed by the first slurry storage slot 112 and the second slurry storage slot 122 respectively, are completely separated without connecting to each other. Therefore, by determining the slurry entering into the upper inlet 111 or the lower inlet 121, the dispensing of the slurry from one of the flow path, i.e. the first flow path or the second flow path, is controlled. The slurry is dispensed from the middle portion, the first flow path, or the two sides, the second flow pate, of the coating nozzle 20 is selectable or adjustable. Therefore, coating in both longitudinal and lateral directions are made to achieve frame-shaped coating with single one process of single one coating head. In other words, the object to be coated is maintained to be driven in only one direction without turning or other actions, and frame-shaped coating can be achieved through the slot die coating apparatus 1 of this invention. The more detailed description presented below.

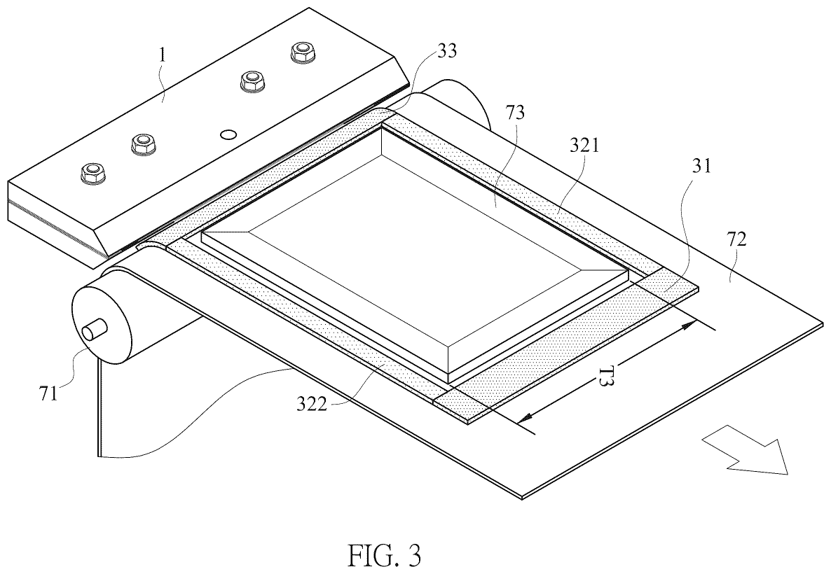

Please refer to FIG. 3, the slot die coating apparatus 1 of this invention is adapted for coating on a substrate 72 with an obstacle 73 to form a frame-shaped coating around the obstacle 73. The obstacle 73 may be a semiconductor chip disposed on the substrate 72 or any other component protruded from the surface of the substrate 72. The frame includes at least a first lateral side 31 and a second lateral side 32, which are lateral sides, close to the front and rear ends of the obstacle 73, and a first longitudinal side 321 and a second longitudinal side 322, which are longitudinal sides, close to the two sides of the obstacle 73. As shown in the figure, if the substrate 72 is thinner or flexible, the roller 71 can be utilized to drive the substrate 72 to move relative to the slot die coating apparatus 1. And the slurry is dispensed by the slot die coating apparatus 1 to coat the surface of the substrate 72. However, the roller 71 is only for illustration and is not limited to that this invention can only use the roller 71 to move the substrate 72 relative to the slot die coating apparatus 1 to coat the surface of the substrate 72. Other methods, such as the conveyor or any other means can be used. Moreover, for the completeness of the frame, the first lateral side 31 and the second lateral side 32 have to connect to the first longitudinal side 321 and the second longitudinal side 322. Therefore, the width T1 of the notch 1321 of the upper shim plate 132 has to be overlapped with parts of the first flow path slot 1332 and the second flow path slot 1333. The first flow path slot 1332 and the second flow path slot 1333 will be located at two ends of the notch 1321 respectively. The first flow path slot 1332 is partially overlapped with the notch 1321, and the second flow path slot 1333 is also partially overlapped with the notch 1321, see FIGS. 1-2. In other words, the width of the notch 1321 is T1. A distance between an inner side wall of the first flow path slot 1332 and an inner side wall of the second flow path slot 1333 is T2. The length of the lateral side of the obstacle 73 is T3. The magnitude relationship of the is T1>T2>T3.

Moreover, please refer to FIG. 3, the obstacle 73 is the component, which is preformed on the surface of the substrate 72 before coating the frame. Due to the component is with a certain height, it is so-called the obstacle 73. The type of the component is not limited. When coating the first longitudinal side 321 and the second longitudinal side 322 on the both sides of the obstacle 73, the slot die coating apparatus 1 needs to pass the obstacle 73 in the single one coating process. It is considered that the obstacle 73 is with a certain height, to prevent it from scratching the surface of the component, the slot die coating apparatus 1 is moved far away from the surface of the substrate 72 during coating the first longitudinal side 321 and the second longitudinal side 322, comparing to coat the first longitudinal side 321 and the second longitudinal side 322. The more detailed description presented below corresponding to the process.

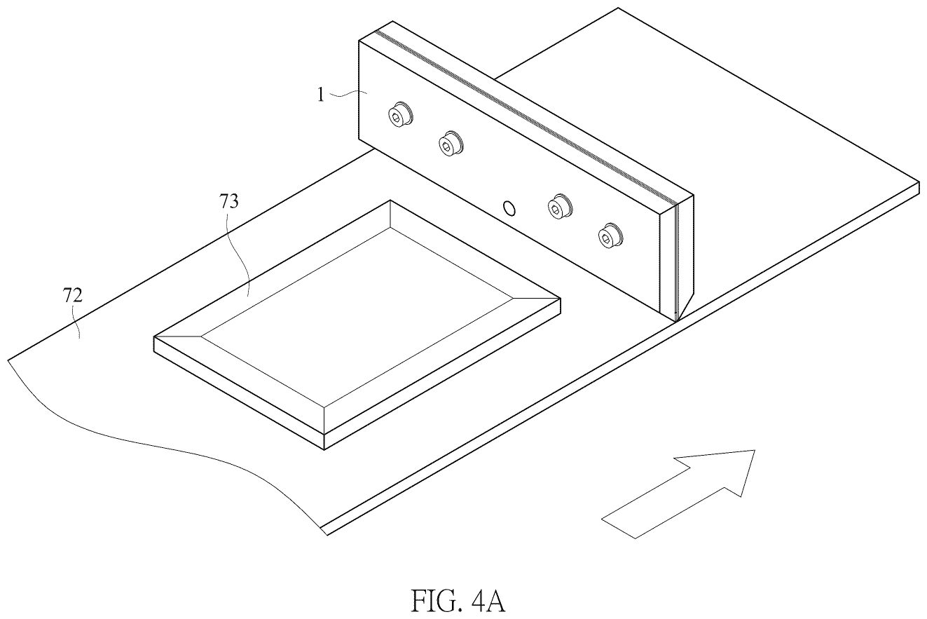

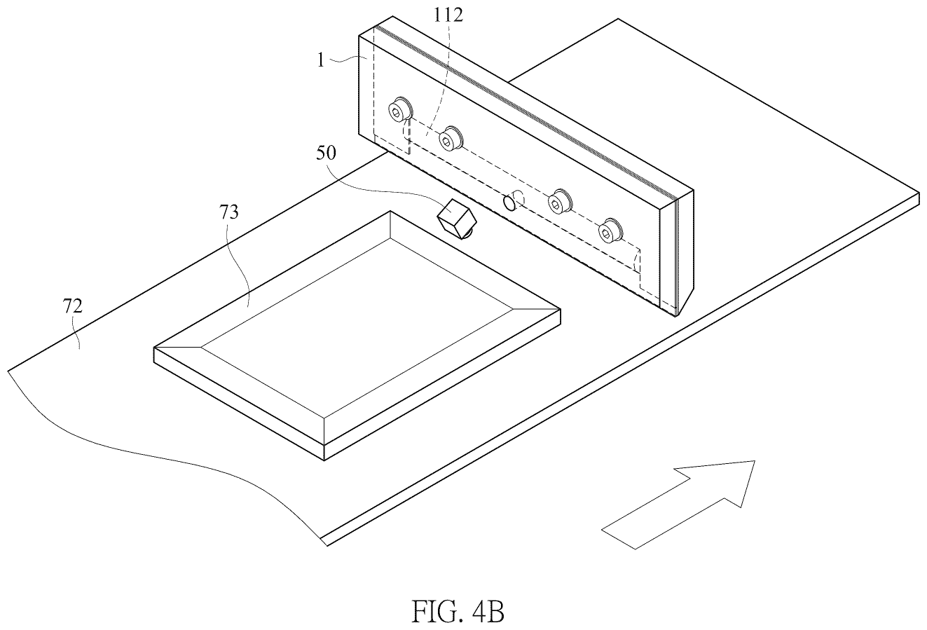

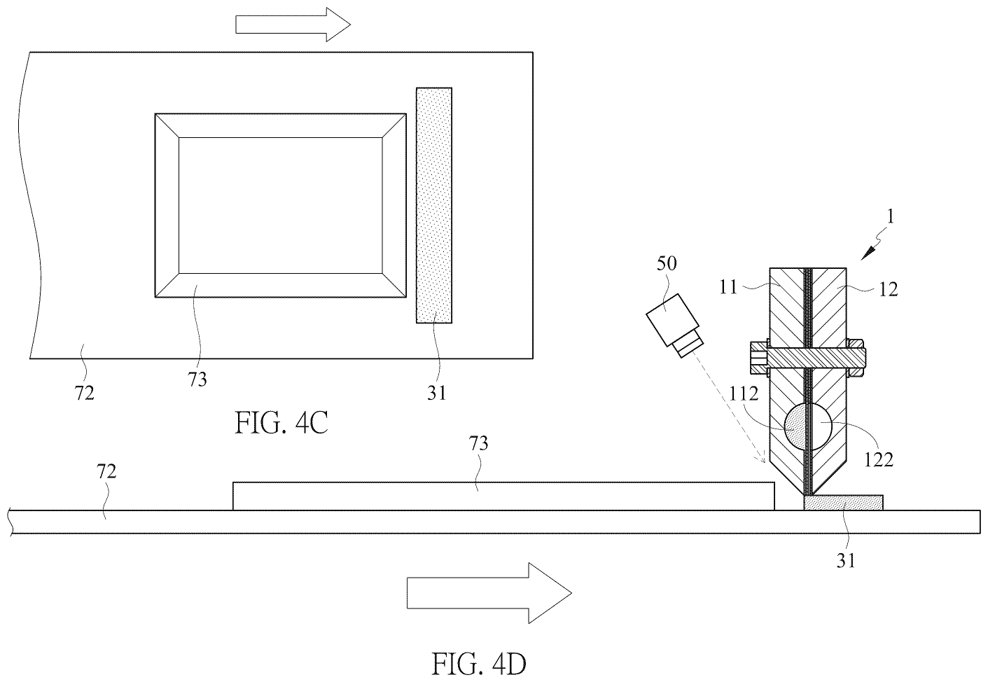

This invention discloses a slot die coating method, please refer to FIG. 4A. The slot die coating apparatus 1 of this invention is utilized for coating on the substrate 72 with the obstacle 73. The slurry is dispensed around the obstacle 73 of the substrate 72 to form a frame. As above-mentioned, the feeder of the slot die coating apparatus 1, the driving system of the substrate 72, etc. are not the main features of this invention. Therefore, in the following figures, including this figure, do not present these devices or equipment. Also, in the figure, only one obstacle 73 is presented for illustration. If mass production is considered, the obstacles 73 on the substrate 72 can also be designed to be arranged in multiple or periodical configurations. The first flow path and the second flow path can be switched during predetermined time or progress for control. Moreover, as shown in FIG. 4D, a sensor 50 may be used to detect a relative position of the obstacle 73 of the substrate 72 with respect to the slot die coating apparatus 1 for more precise coating. The following description is presented in case of having the sensor 50.

Please refer to FIG. 4B, the substrate 72 with the obstacle 73 and the slot die coating apparatus 1 are provided. The structure of the slot die coating apparatus 1 is as above-mentioned and shown in FIG. 1, which can switch to dispense the slurry form the middle portion from the first outlet 21 of the first flow path and the both sides from the second outlet 22 of the second flow path. Please refer to FIGS. 4C-4D, the first flow path of the the slot die coating apparatus 1 is utilized to dispense the slurry in front of the obstacle 73 of the substrate 72 to form a first lateral side 31. Please also refer to FIG. 2, it means that the slurry is fed from the upper inlet 111. The slurry is flowed through the first slurry storage slot 112 and exposed from the notch 1321 of the upper shim plate 132 to dispense from the first outlet 21.

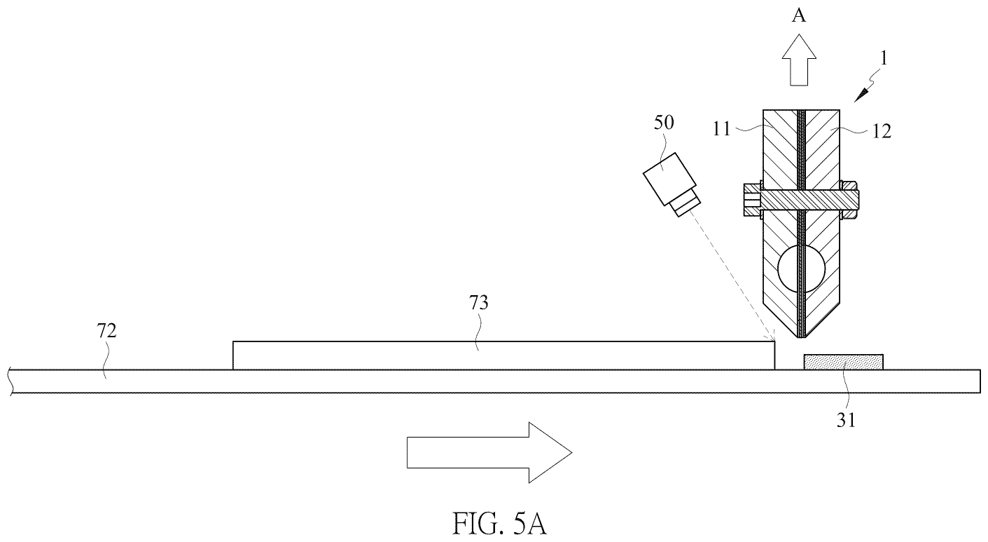

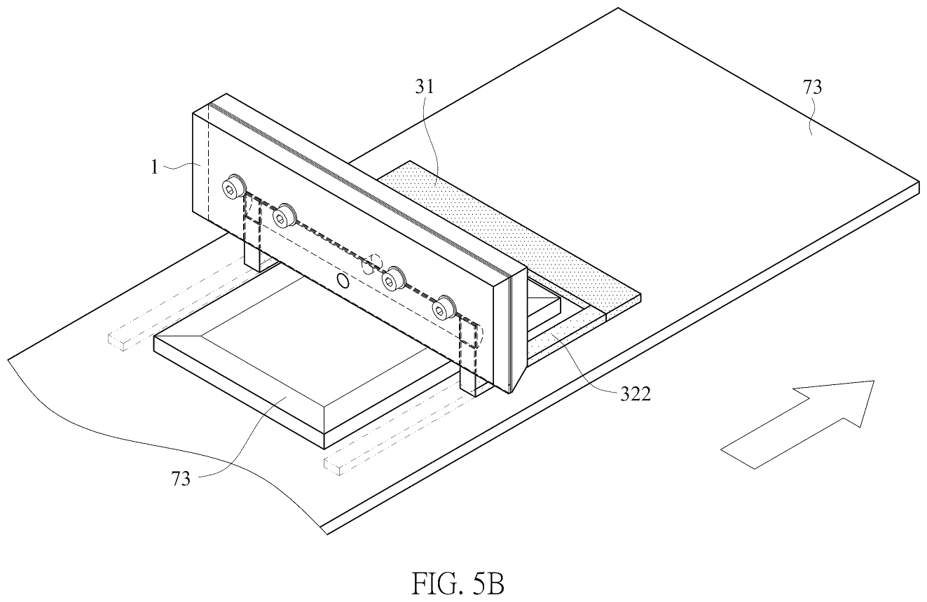

When the sensor 50 detects that it is close to the obstacle 73, please refer to FIG. 5A, the dispensing from the first flow path is closed. And the slot die coating apparatus 1 is moved far away from the substrate 72. As shown in the figure, the movement direction A of the slot die coating apparatus 1 is upward. In other words, the slot die coating apparatus 1 is moved upward along the Z-axis direction of the plane where the substrate 72 is located. Therefore, the first outlet 21 of the first flow path in moved upward to prevent it from colliding the obstacle 73. The lifted height of the slot die coating apparatus 1 is depended on the thickness of the obstacle 73 and the original height of the slot die coating apparatus 1. Hence, after the height of the slot die coating apparatus 1 is lifted, the distance between the slot die coating apparatus 1 and the substrate 72 is increased. The first outlet 21 colliding with the obstacle 73 and resulting in damage or scratches to the first outlet 21 or the obstacle 73 can be avoided.

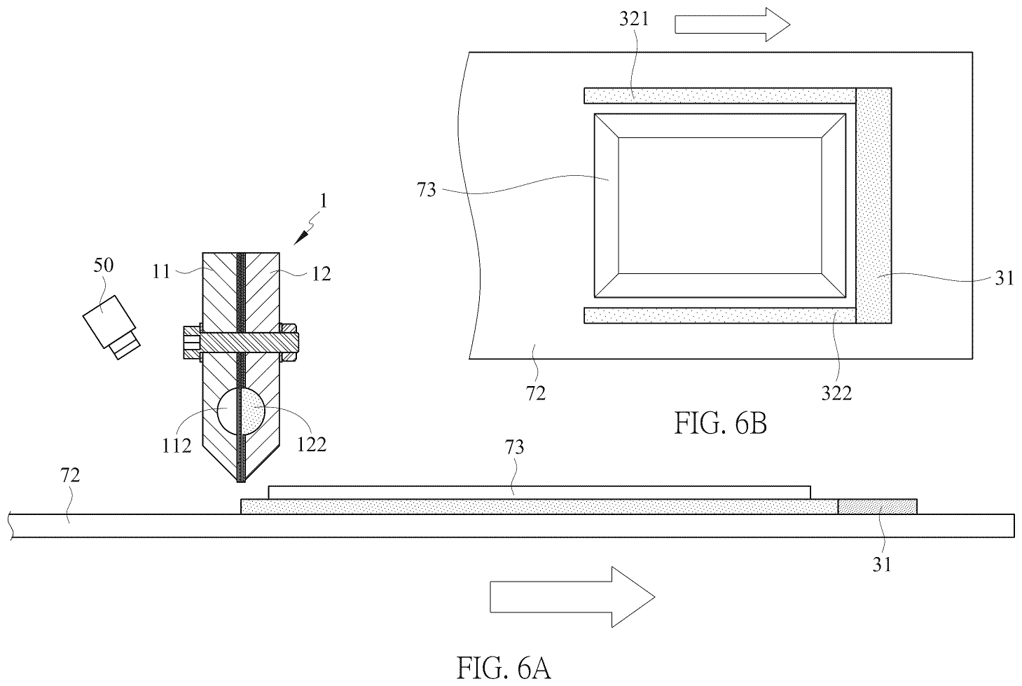

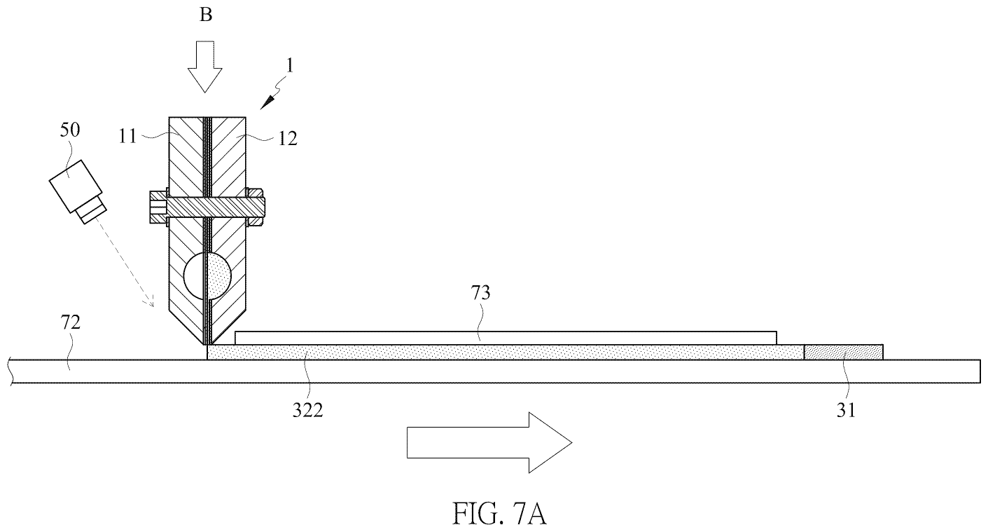

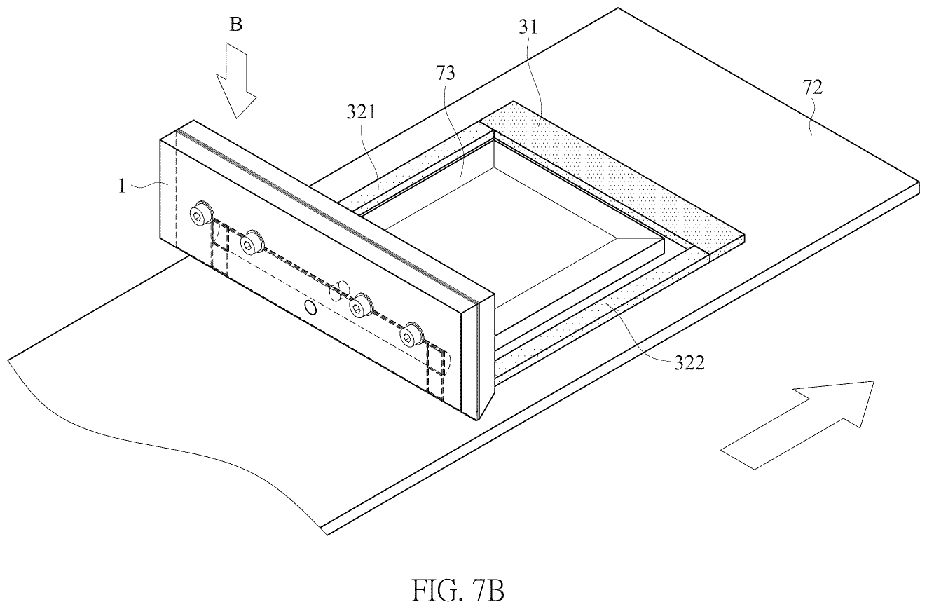

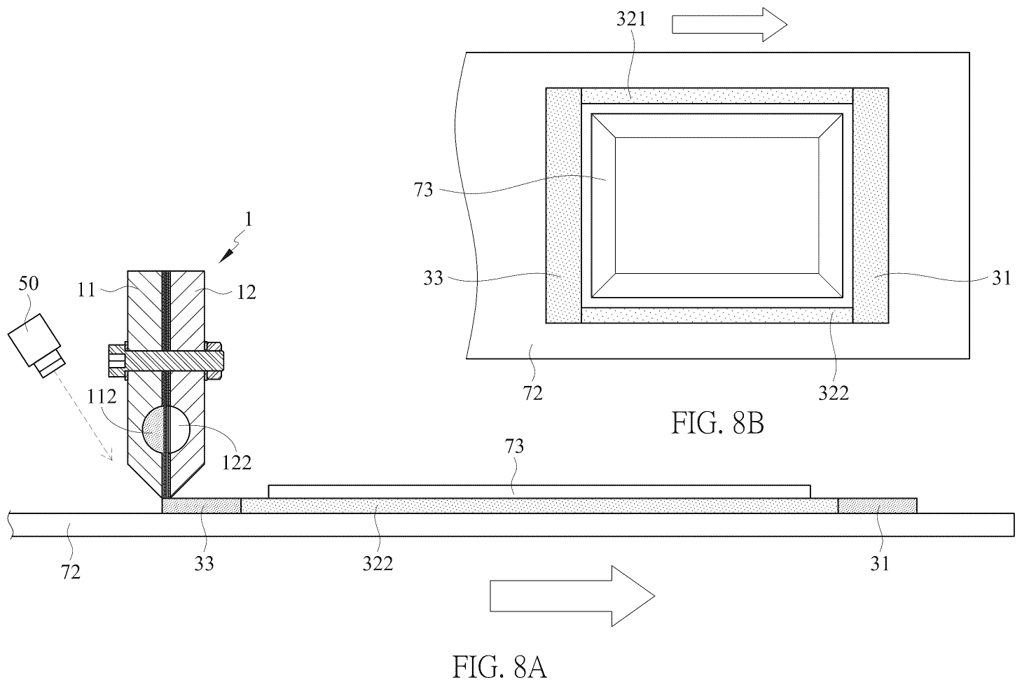

Then the second flow path of the slot die coating apparatus is utilized to coat the both sides of the obstacle 73 on the substrate 72 to form the first longitudinal side 321 and the second longitudinal side 322, referring to FIG. 5B. The second outlet 22 of the second flow path is continued to be utilized for coating until the first longitudinal side 321 and the second longitudinal side 322 located on both sides of the obstacle 73 is complete, shown in FIGS. 6A-6B. Please refer to FIGS. 7A-7B, the dispensing from the second flow path is closed when detecting pass the obstacle 73. And the slot die coating apparatus 1 is moved downward to the original height with respect to the substrate 72. As shown in the figure, the movement direction B of the slot die coating apparatus 1 is downward. In other words, the slot die coating apparatus 1 is moved downward along the Z-axis direction of the plane where the substrate 72 is located. The the first outlet 21 of the first flow path is utilized to dispense the slurry behind the obstacle 73 of the substrate 72 to form the second lateral side 33. Please refer to FIG. 8A-8B, the coating of the second lateral side 33 is the same as the above-mentioned coating of the second lateral side 31. Therefore, the repeated description is omitted. Accordingly, the coating of the frame around the obstacle 73 is completed. Only single one slot die coating apparatus 1 is used in a single process without changing the driven direction of the substrate 72 as in the conventional coating. Also, the height for the slot die coating apparatus 1 during coating is controlled, i.e. movement in the Z-axis direction, to optimize the coating of the entire frame without colliding with the obstacle 73 on the substrate 72.

It can be seen from the above-mentioned manufacturing processes for coating the entire frame, that the substrate 72 only moves along a single axis (horizontal direction in the figure) relative to the slot die coating apparatus 1, and the slot die coating apparatus 1 only moves along the Z-axis relative to the substrate 72 (direction perpendicular to the plane of substrate 72). Unlike the conventional coating, the substrate needs to be rotated relative to the coating head device to complete the entire frame coating. Therefore, the present invention can use rollers or conveyor to transport the substrate 72 to achieve high-efficiency and continuous production.

Accordingly, the present invention provides a slot die coating apparatus and the coating method thereof, which can achieve a single one process to form a frame-shaped coating on substrates with obstacles without significantly changing the structure of the slot coating head device by utilizing the shim group. Therefore, the process complexity and manufacturing costs are significantly reduced. Also, the flow path of the slot die coating apparatus is divided into a first flow path and a second flow path to coat the lateral and longitudinal sides of the frame-shaped coating respectively. Therefore, a frame-shaped coating around the component is achieved by a single slot die coating apparatus via a single one process. Further, the height of the slot die coating apparatus is adjustable to avoid the collision between the slot die coating apparatus and the components on the substrate, and the coating quality is optimized.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A slot die coating apparatus, adapted for coating on a substrate, comprising:
an upper mold, including an upper inlet and a first slurry storage slot connected to the upper inlet;
a lower mold, including a lower inlet and a second slurry storage slot connected to the lower inlet; and
a shim group, sandwiched between the upper mold and the lower mold, comprising:
a central shim plate;
an upper shim plate, having at least one notch and sandwiched between the central shim plate and the upper mold, wherein the notch is connected to the first slurry storage slot to dispense a slurry from the upper inlet for coating; and
a lower shim plate, sandwiched between another side of the central shim plate and the lower mold and having at least one first flow path slot and at least one second flow path slot to dispense a slurry from the lower inlet for coating, which are connected to the second slurry storage slot, wherein the first flow pate slot and the second flow path slot are located at two ends of the notch respectively and are partially overlapped with the notch.

2. The slot die coating apparatus of claim 1, wherein the central shim plate separates completely the first slurry storage slot and the second slurry storage slot.

3. The slot die coating apparatus of claim 1, wherein a width of the notch of the upper shim plate is slightly larger than a distance between an inner side wall of the first flow path slot and an inner side wall of the second flow path slot.

4. The slot die coating apparatus of claim 1, further comprising a sensor to detect a relative position of an obstacle of the substrate with respect to the slot die coating apparatus and a height of the slot die coating apparatus is adjustable according to the relative position.

5. The slot die coating apparatus of claim 4, wherein the sensor detects the relative position of the obstacle to determine the notch or the first flow path slot and the second flow path slot to expose the slurry.

6. A slot die coating method, adapted for coating on a substrate with an obstacle, utilized the slot die coating apparatus of claim 1 to coat the slurry around the obstacle of the substrate to form a frame, the slot die coating method comprising the steps of:
providing the substrate with the obstacle;
dispensing the slurry from the notch in front of the obstacle of the substrate to form a first lateral side;
closing the dispensing from the notch when detecting close to the obstacle and moving the slot die coating apparatus far away from the substrate to prevent the slot die coating apparatus from colliding the obstacle;
dispensing the slurry from the first flow path slot and the second flow path slot on both sides of the obstacle of the substrate to form a first longitudinal side and a second longitudinal side on the substrate;
closing the dispensing from the first flow path slot and the second flow path slot when detecting pass the obstacle and moving the slot die coating apparatus to an original height with respect to the substrate; and
dispensing the slurry from the notch behind the obstacle of the substrate to form a second lateral side.

7. A slot die coating apparatus, adapted for coating on a substrate, comprising:
a die body, including a flow path and a coating nozzle, wherein the die body receives a slurry from the flow path and dispenses the slurry from the coating nozzle; and
a shim group, disposed in the die body, comprising:
a central shim plate, separating completely the flow path into a first flow path and a second flow path;
an upper shim plate, having a notch in a middle portion and disposed on one side of the central shim plate, wherein the notch is connected to the first flow path to dispense the slurry from a middle portion of the coating nozzle for coating; and
a lower shim plate, disposed on another side of the central shim plate, shielding a middle portion of the second flow path and having a first flow path slot and a second flow path slot on both sides, wherein the first flow path slot and the second flow path slot are connected to the second flow path to dispense the slurry from both sides of the coating nozzle for coating.

8. The slot die coating apparatus of claim 7, further comprising a sensor to detect a relative position of an obstacle of the substrate with respect to the slot die coating apparatus and a height of the slot die coating apparatus is adjustable according to the relative position.

9. The slot die coating apparatus of claim 8, wherein the sensor detects the relative position of the obstacle to determine the middle portion or the both sides of the coating nozzle to expose the slurry.

10. The slot die coating apparatus of claim 7, wherein a width of the notch of the upper shim plate is slightly larger than a distance between an inner side wall of the first flow path slot and an inner side wall of the second flow path slot.
